(19) United States
(12) Patent Application Publication
(10) Pub. No.: US 2024/0160506 A1
(43) Pub. Date: May 16, 2024

(54) OPERATION SUPPORT APPARATUS, SYSTEM, METHOD, AND COMPUTER-READABLE MEDIUM

(71) Applicant: NEC Corporation, Minato-ku, Tokyo (JP)

(72) Inventor: Yuko TAKEMURA, Tokyo (JP)

(73) Assignee: NEC Corporation, Minato-ku, Tokyo (JP)

(21) Appl. No.: 18/281,357

(22) PCT Filed: Mar. 14, 2022
(86) PCT No.: PCT/JP2022/011285

§ 371 Date: Sep. 11, 2023

(30) Foreign Application Priority Data
Mar. 19, 2021 (JP) 2021-045848

(51) Int. Cl. G06F 9/54

(52) U.S. Cl. CPC G06F 9/542

(57) ABSTRACT

To support appropriate maintenance of rules for taking action on events that occurred in an operation system. An operation support apparatus (1) includes: a storage unit (11) configured to store a plurality of pieces of rule information (15l to 15n) defining actions respectively corresponding to a plurality of events occurring in an operation system; a registration unit (12) configured to register history information in the storage unit (11) in a case where an action defined in rule information corresponding to a predetermined event among the plurality of pieces of rule information (15l to 15n) is taken in response to an occurrence of the predetermined event in the operation system, the history information containing occurrence date and time of the event and the rule information for the event; an identification unit (13) configured to identify, based on the history information, rule information in which an occurrence interval of a specific event satisfies a predetermined condition; and an output unit (14) configured to output the identified rule information.

### TECHNICAL FIELD

The present invention relates to an operation support apparatus, a system, a method, and a program, and in particular to an operation support apparatus, a system, a method, and a program for monitoring an operation system.

### BACKGROUND ART

In recent years, an operation of an information system has become increasingly automated. For example, based on an event handling rule defined in advance, an action command is determined from notification information of an event that occurred in the information system, and the action command is automatically executed.

Examples of the technology related to automation of operations include Patent Literatures 1 and 2. Patent Literature 1 discloses a technology related to a failure recovery apparatus that can attempt to recover from a failure other than failures described in a failure handling rule in a case where the failure occurs. Patent Literature 2 discloses a technology related to a failure recovery apparatus that addresses a predetermined rule based on priorities of a plurality of failure handling rules and an operation state of a system.

### CITATION LIST

### Patent Literature

Patent Literature 1: Japanese Unexamined Patent Application Publication No. 2005-346331
Patent Literature 2: Japanese Unexamined Patent Application Publication No. 2005-038223

### SUMMARY OF INVENTION

### Technical Problem

Here, in a case where the behavior or a status of an operation system changes due to system modification or the like, event handling rules for operation automation of the operation system may not meet a condition and may not function as rules. Normally, it is desirable to change the event handling rules in correspondence with the system modification. However, operation systems are becoming larger and larger, and it is not always possible to change the relevant event handling rules to accommodate the system modification. In addition, since there are many event handling rules, maintenance of the rules is complicated. Therefore, there is a problem that it is difficult to maintain the event handling rules so that they function properly.

In view of the above-described problems, it is an object of the present disclosure to provide an operation support apparatus, a system, a method, and a program for supporting appropriate maintenance of rules for taking action on events that occurred in an operation system.

### Solution to Problem

An operation support apparatus according to a first aspect of the present disclosure includes:
a storage unit configured to store a plurality of pieces of rule information defining actions respectively corresponding to a plurality of events occurring in an operation system;
a registration unit configured to register history information in the storage unit in a case where an action defined in rule information corresponding to a predetermined event among the plurality of pieces of rule information is taken in response to an occurrence of the predetermined event in the operation system, the history information containing occurrence date and time of the event and the rule information for the event;
an identification unit configured to identify, based on the history information, rule information in which an occurrence interval of a specific event satisfies a predetermined condition; and
an output unit configured to output the identified rule information.

An operation support system according to a second aspect of the present disclosure includes:
a management terminal; and
an operation support apparatus, wherein
the operation support apparatus is configured to:
receive, from the management terminal, a plurality of pieces of rule information defining actions respectively corresponding to a plurality of events occurring in an operation system, and store the plurality of pieces of rule information in a storage device;
register history information in the memory device when an action defined in the rule information corresponding to a predetermined event among the plurality of pieces of rule information is taken in response to occurrence of the predetermined event in the operation system, the history information containing occurrence date and time of the event and the rule information for the event;
identify, based on the history information, rule information in which an occurrence interval of a specific event satisfies a predetermined condition; and
output the identified rule information to the management terminal.

An operation support method according to a third aspect of the present disclosure causes a computer to execute:
in a case where an action defined in rule information corresponding to a predetermined event among a plurality of pieces of rule information stored in a storage device configured to store the plurality of pieces of rule information defining actions respectively corresponding to a plurality of events occurring in an operation system is taken in response to the occurrence of the predetermined event in the operation system, registering history information in the memory device, the history information containing occurrence date and time of the event and the rule information for the event;
identifying, based on the history information, rule information in which an occurrence interval of a specific event satisfies a predetermined condition; and
outputting the identified rule information.

An operation support program according to a fourth aspect of the present disclosure causes a computer to execute:
in a case where an action defined in rule information corresponding to a predetermined event among a plurality of pieces of rule information stored in a storage device configured to store the plurality of pieces of rule information defining actions respectively corresponding to a plurality of events occurring in an operation system is taken in response to the occurrence of the predetermined event in the operation system, registering history information in the memory device, the history information containing occurrence date and time of the event and the rule information for the event;
identifying, based on the history information, rule information in which an occurrence interval of a specific event satisfies a predetermined condition; and
outputting the identified rule information.

### Advantageous Effects of Invention

According to the present disclosure, it is possible to provide an operation support apparatus, a system, a method, and a program for supporting appropriate maintenance of rules for taking action on events that occurred in an operation system.

### BRIEF DESCRIPTION OF DRAWINGS

FIG. 1 is a block diagram illustrating a configuration of an operation support apparatus according to a first example embodiment.

FIG. 2 is a flowchart illustrating a flow of an operation support method according to the first example embodiment.

FIG. 3 is a block diagram illustrating an overall configuration of an operation support system according to a second example embodiment.

FIG. 4 is a block diagram illustrating a configuration of an operation support apparatus according to the second example embodiment.

FIG. 5 is a flowchart illustrating a flow of an action process for an occurred event according to the second example embodiment.

FIG. 6 is a sequence diagram illustrating a flow of an inappropriate rule detection and update process according to the second example embodiment.

FIG. 7 is a diagram illustrating a concept of a detection example of a rule for which an event is not solved even after an action according to the second example embodiment.

FIG. 8 is a diagram illustrating a concept of a detection example of a rule whose condition is no longer met due to a change in a system status according to the second example embodiment.

FIG. 9 is a diagram illustrating a concept of an example in which an event is solved by rule update according to the second example embodiment.

### EXAMPLE EMBODIMENTS

Hereinafter, example embodiments of the present disclosure will be described in detail with reference to the drawings. In each of the drawings, the same or corresponding elements are denoted by the same reference numerals, and repeated description thereof will be omitted as necessary for clarity of description.

### First Example Embodiment

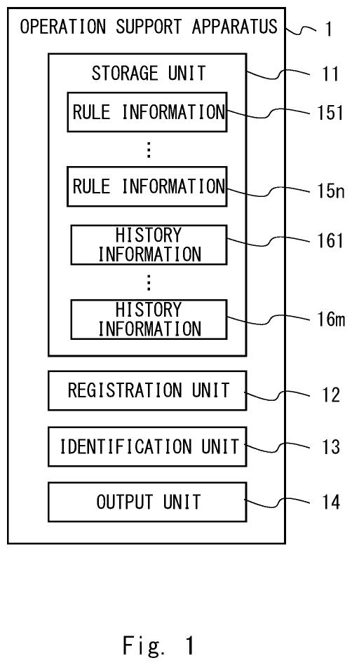

FIG. 1 is a block diagram illustrating a configuration of an operation support apparatus 1 according to a first example embodiment. The operation support apparatus 1 is an information processing apparatus for executing operation management and support of operations by administrators for an operation system. Here, the operation system is an information system configured by a plurality of monitoring target devices such as computers (servers), communication devices (network devices), and storage devices. The operation system is, for example, a service providing system that provides one or more services via a communication network, a business system within a company, or the like. In addition, the operation system may be linked to an external information system.

The operation support apparatus 1 includes a storage unit 11, a registration unit 12, an identification unit 13, and an output unit 14. The storage unit 11 stores rule information 15l to 15n (n is a natural number of 2 or more) and history information 16l to 16m (m is a natural number of 2 or more). The rule information 15l and the like are information defining actions respectively corresponding to a plurality of events that may occur in the operation system. The events are not limited to a system failure (hardware, software, or network) that leads to a service outage of the operation system, but includes a situation where the system is operating but the provided services do not meet requirements. Further, the actions include processing instructions and commands for solving or avoiding the event. For example, the actions may include a command to restart an operating system (OS), middleware, or an application, and a command to execute a data correction patch. The history information 16l and the like are histories in a case where an action is taken. The history information 16l and the like contain occurrence date and time of an event and rule information for the event.

The registration unit 12 registers, in a case where an action defined in rule information corresponding to a predetermined event among a plurality of pieces of rule information is taken in response to an occurrence of the predetermined event in the operation system, history information containing the occurrence date and time of the event and the rule information for the event in the storage unit 11.

The identification unit 13 identifies, based on the history information, rule information in which an occurrence interval of a specific event satisfies a predetermined condition.

The output unit 14 outputs the identified rule information.

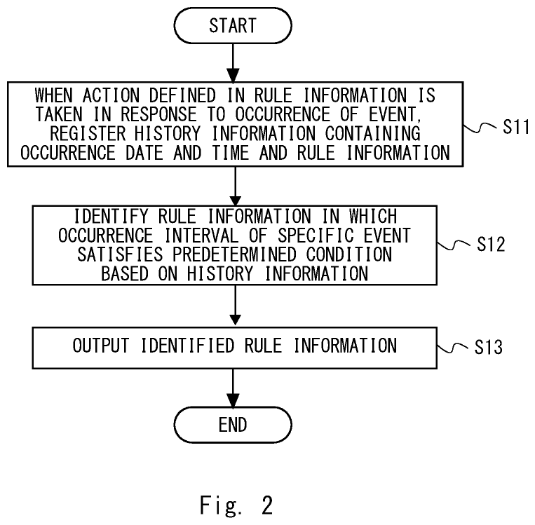

FIG. 2 is a flowchart illustrating a flow of an operation support method according to the first example embodiment. First, as a premise, it is assumed that a predetermined event occurred in the operation system. At this time, the operation support apparatus 1 receives a notification of an event occurrence from the operation system or a monitoring system of the operation system. At this time, the operation support apparatus 1 identifies the rule information corresponding to the notified event from the storage unit 11 storing the rule information 15l to 15n, and executes an action defined in the identified rule information.

Then, in a case where the above-described action is executed, the registration unit 12 registers, in the storage unit 11, the history information 16l containing the occurrence date and time of the event and the rule information for the event (S11). Next, the identification unit 13 identifies rule information in which an occurrence interval of a specific event satisfies a predetermined condition based on the history information 16l to 16m, (S12). That is, the “specific event” is not limited to the “predetermined event”. Thereafter, the output unit 14 outputs the identified rule information (S13). For example, the output unit 14 may output the identified rule information to a management terminal of an administrator. As a result, the management terminal displays the identified rule information. Therefore, the administrator can grasp the rule information in which the occurrence interval satisfies the predetermined condition among the events that have occurred in the operation system and for each of which an action has been taken.

The rule information in which the occurrence interval satisfies the predetermined condition contains a case where a trend of an occurrence of an event has changed compared to before. For example, the occurrence interval of the event may be shorter than before. That is, it is conceivable that the event may have recurred in a short period of time even though the action defined in the rule information corresponding to the occurred event has been executed. Alternatively, there may be a case where an event that had occurred periodically no longer occurs and no action is taken. In this case, it is conceivable a case where an event no longer conforms to a rule due to a change in the state of the system, or a case where a rule becomes unnecessary. As described above, in the present example embodiment, the occurrence interval of the event is analyzed from an execution history of the action taken in response to the event, and the rule information is identified and output in a case where the occurrence interval satisfies the predetermined condition. Therefore, the administrator or the like can examine and implement maintenance or the like of the rule information using the output rule information as a clue. This makes it possible to support appropriate maintenance of the rule for taking action on the event that occurred in the operation system.

Note that the operation support apparatus 1 includes a processor, a memory, and a storage device as an unillustrated configuration. In addition, the storage device stores a computer program in which the processing of the operation support method according to the present example embodiment is implemented. Then, the processor reads the computer program from the storage device onto the memory, and executes the computer program. As a result, the processor realizes functions of the registration unit 12, the identification unit 13, and the output unit 14.

Alternatively, each component of the operation support apparatus 1 may be realized by dedicated hardware. In addition, some or all of the components of each apparatus or device may be realized by, for example, a general-purpose or dedicated circuitry, a processor, or a combination thereof. These may be configured by a single chip or may be configured by a plurality of chips that are connected to each other via a bus. Some or all of the components of each apparatus or device may be realized by, for example, a combination of the above-described circuit and a program. Furthermore, for example, a central processing unit (CPU), a graphics processing unit (GPU), a field-programmable gate array (FPGA), or a quantum processor (quantum computer control chip) can be used as the processor.

Furthermore, in a case where some or all of the components of the operation support apparatus 1 are realized by a plurality of information processing apparatuses, circuits, and the like, the plurality of information processing apparatuses, the circuits, and the like may be arranged in a centralized manner or in a distributed manner. For example, the information processing apparatuses, the circuits, and the like may be realized as a form, such as a client-server system or a cloud computing system, in which the information processing apparatuses, the circuits, and the like are connected to each other through a communication network. Furthermore, the function of the operation support apparatus 1 may be provided in a software as a service (SaaS) format.

### Second Example Embodiment

Here, problems to be solved by the present example embodiment will be described in detail. First, an artificial intelligence (AI) model could be used for operational automation. However, there is a problem that the use of the AI model incurs a learning cost and a threshold for use is high. Therefore, the operational automation can be introduced relatively easily by a rule-based engine using rule information defining the actions to be taken in response to the events described above.

Here, as described above, the event is not limited to a failure that causes a system to stop, but includes a situation in which the system itself is operating normally, such as failure to meet service specifications. The action taken in response to the occurrence of the event is not limited to recovery from a system failure. For example, as an action, data correction (data patch application), restart, or the like may be performed as an operation every time an event occurs. That is, although the system should be modified originally, the operation may be continued by taking action from the viewpoint of cost effectiveness (occurrence frequency, modification cost, modification time, the degree of difficulty, etc.) and the like. Therefore, in order to realize such an operation, rule information defining actions to be taken under the condition of an occurrence of an event is used.

However, as a result of system modifications, an event that has occurred in the past may become a different event and the existing rules may no longer conform. Therefore, it is desirable to change the rule information together with the change in the operation system. However, in a case where a creator or administrator of the rules is different from a system modifier (repairer), cooperation may be difficult. Therefore, omissions in the maintenance of rules that affect system changes may occur. In addition, due to system changes, unexpected changes in the system status may occur, and these may cause events to change and make the events undetectable by existing rules. Therefore, it may happen that the rule engine (the operation support apparatus) does not function normally (events cannot be detected as intended) or that actions are not taken as expected.

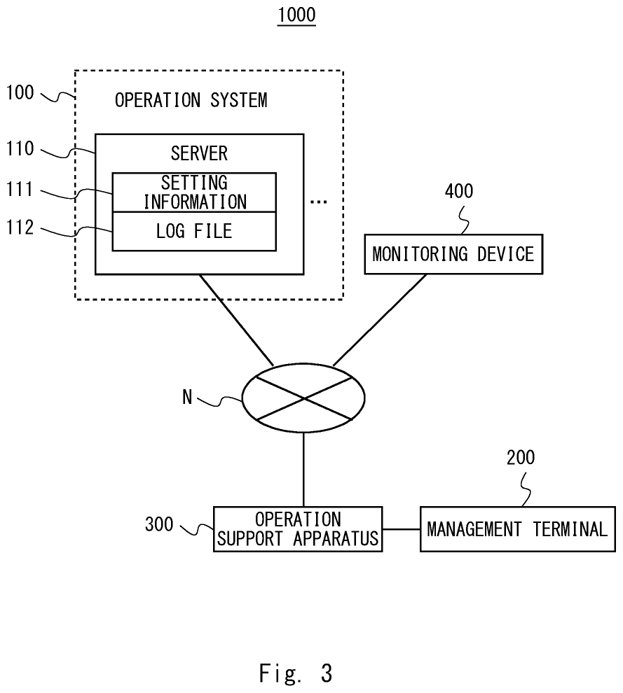

Therefore, a second example embodiment is a specific example of the first example embodiment described above, and a solution to at least a part of the above-described problem will be described below. FIG. 3 is a block diagram illustrating an overall configuration of an operation support system 1000 according to the second example embodiment. The operation support system 1000 includes an operation system 100, a management terminal 200, an operation support apparatus 300, and a monitoring device 400. The operation system 100, the monitoring device 400, and the operation support apparatus 300 are connected via at least a network N. Here, the network N is a communication network such as the Internet or dedicated lines.

The operation system 100 may be the above-described service providing system, a business system within a company, or the like. The operation system 100 includes at least one or more monitoring target devices such as a computer server, a network device, and a storage device. The operation system 100 may be any system that can acquire monitoring target information from the monitoring device 400 or the operation support apparatus 300. Furthermore, the operation system 100 may be connected to an external system (not illustrated). The operation system 100 includes, for example, a gateway (GW) server, a firewall (FW), a web server, an application (AP) server, a database (DB) server, a router, a switch, a storage device, and the like. However, the configuration of the operation system 100 is not limited thereto. In addition, a connection relationship between the configurations within the operation system 100 is not particularly limited.

FIG. 3 illustrates a server 110 as a part of the configuration of the operation system 100. The server 110 is an example of the computer server described above, and it assumes that an operating system (OS), middleware, an application, and the like operate thereon. Alternatively, the server 110 may be a storage device. The server 110 includes setting information 111 and a log file 112. The setting information 111 is a setting file of an OS, middleware, an application, or the like. Alternatively, the setting information 111 is not limited to a file, and may be an execution result by various status acquisition commands. The log file 112 is a file in which log information output by an OS, middleware, an application, or the like is recorded. Furthermore, the operation system 100 may include a network device. The network device may include setting information and a log file.

The monitoring device 400 monitors each monitoring target device of the operation system 100 via the network N and acquires monitoring target information. In a case where the monitoring device 400 detects occurrence of an event from the monitoring target information, the monitoring device 400 transmits a notification of event occurrence to the operation support apparatus 300 via the network N. The monitoring device 400 may monitor each monitoring target device in accordance with a predetermined monitoring schedule. The monitoring device 400 may acquire the setting information 111 and the log file 112 from the server 110 as the monitoring target information. Alternatively, the monitoring device 400 may acquire a specific parameter value in the setting information 111. Alternatively, the monitoring device 400 may acquire a log message (a message ID, occurrence date and time of an event, and the like) written in the log file 112. Alternatively, the monitoring device 400 may execute a status acquisition command for the server 110, and acquire an execution result of the command. The monitoring device 400 may detect the occurrence of an event by extracting an error message or the like from the acquired monitoring target information using a predetermined extraction logic. Alternatively, the monitoring device 400 may notify the operation support apparatus 300 of the setting information 111 and the log file 112 thus acquired by transmitting them to the operation support apparatus 300 via the network N.

The management terminal 200 is a terminal device used by an operation manager in manipulation of the operation work, and is, for example, a personal computer or the like. The management terminal 200 is communicably connected to the operation support apparatus 300 via a network or the like. The management terminal 200 receives an input of information such as rule information and an action command execution file in response to manipulation of the operation manager, and transmits and registers the information to the operation support apparatus 300. In addition, the management terminal 200 receives an input of update information of the rule information from the operation manager, and transmits the update information to the operation support apparatus 300 to update the rule information.

The operation support apparatus 300 is an example of the operation support apparatus 1 described above. The operation support apparatus 300 is an information processing apparatus that performs a registration process for rule information and the like, an action process for an occurred event, and an inappropriate rule detection and update process, and the like (operation support method). The operation support apparatus 300 may be redundant in a plurality of servers, and each functional block may be realized by a plurality of computers.

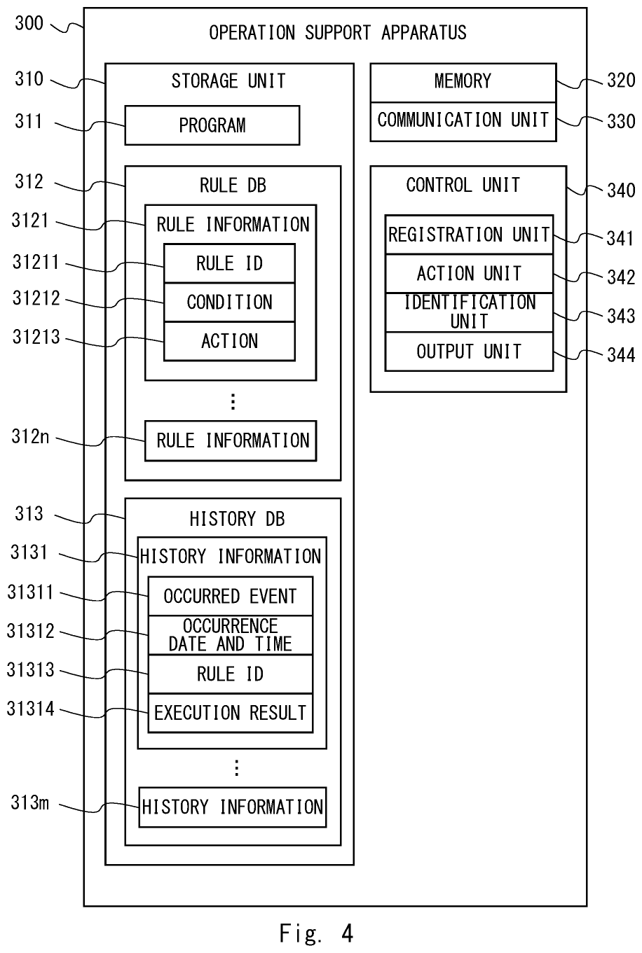

FIG. 4 is a block diagram illustrating a configuration of the operation support apparatus 300 according to the second example embodiment. The operation support apparatus 300 includes a storage unit 310, a memory 320, a communication unit 330, and a control unit 340. The storage unit 310 is an example of the storage unit 11 described above. The storage unit 310 is an example of a storage device such as a hard disk, a flash memory, or a solid state drive (SSD). The storage unit 310 stores a program 311, a rule DB 312, and a history DB 313. The program 311 is a computer program in which processing of the operation support method according to the second example embodiment is implemented.

The rule DB 312 is a database that manages a plurality of pieces of rule information 3121 to 312n. The rule information 3121 is information in which a rule ID 31211, a condition 31212, and an action 31213 are associated with each other. The rule ID 31211 is identification information of the rule information. The condition 31212 is a condition for executing an action, including an event that occurred. Specifically, an event is a failure, an error, a status change, or the like that occurred in the monitoring target device of the operation system 100. For example, the condition 31212 may include the setting information 111 or the log file 112 of the server 110, or an ID of a specific error message in the notification of the event occurrence. The action 31213 is information indicating the action content to be taken in a case where the occurred event satisfies the condition 31212. The action 31213 is an execution command, a job ID, or the like for the monitoring target device or related devices where an event occurred. For example, the action 31213 may be a command to restart the OS, middleware, or application of the server 110, a command to execute the command via the network N, or the like. In addition, each piece of rule information 3122 (not illustrated) . . . 312n has the same configuration as the rule information 3121, but has a different rule ID 31211 and a condition 31212.

The history DB 313 is a database that manages a plurality of pieces of history information 3131 to 313m. The history information 3131 or the like is a history of actions taken in response to the occurrence of an event. The history information 3131 is information in which an occurred event 31311, occurrence date and time 31312, a rule ID 31313, and an execution result 31314 are associated with each other. The occurred event 31311 is information for identifying the event that occurred. The occurred event 31311 is an event defined in the condition 31212 described above, for example, an ID of a specific error message. The occurrence date and time 31312 is the date and time when the occurred event 31311 occurred. The occurrence date and time 31312 may be information contained in the notification of the event occurrence or reception date and the date and time of receipt of the occurrence notification in the operation support apparatus 300. Note that the date and time of the execution of the action 31213 may be used instead of the occurrence date and time 31312. The rule ID 31313 is the identification information of the rule information and is information corresponding to the rule ID 31211 and the like in which the action taken is defined. The execution result 31314 is the result of the action taken. The execution result 31314 is, for example, information indicating that the action was normally or abnormally completed.

The memory 320 is a volatile storage device, such as a random access memory (RAM), and is a storage area for temporarily holding information during the operation of the control unit 340. The communication unit 330 is a communication interface with the network N.

The control unit 340 is a processor that controls each component of the operation support apparatus 300, that is, a control device. The control unit 340 reads the program 311 from the storage unit 310 into the memory 320 and executes the program 311. As a result, the control unit 340 realizes the functions of the registration unit 341, the action unit 342, the identification unit 343, and the output unit 344.

The registration unit 341 is an example of the registration unit 12 described above. The registration unit 341 performs registration and update processing, and the like of rule information. The registration unit 341 registers the rule information received from the management terminal 200 in the rule DB 312 of the storage unit 310. Note that the format of the received rule information may be in various formats. In this case, the registration unit 341 may convert the received rule information into a specific format such as the rule information 3121 described above using a conversion logic according to the format of the rule information, and register it in the rule DB 312. In addition, the registration unit 341 may register the action command execution file received from the management terminal 200 in the storage unit 310. In addition, the registration unit 341 registers the history information in the history DB 313 of the storage unit 310 after taking action by the action unit 342 to be described later. In addition, the registration unit 341 updates the corresponding rule information in the rule DB 312 based on the update information of the rule information received from the management terminal 200.

The action unit 342 performs an action process on the occurred event. When the action unit 342 receives a notification of event occurrence from the monitoring device 400, the action unit 342 identifies the rule information in which a condition corresponding to the event is defined from the rule DB 312 and executes the action defined in the identified rule information for the applicable monitoring target device or the like. Note that the action unit 342 may acquire monitoring target information from the monitoring target device of the operation system 100 via the network N, analyze the monitoring target information, and detect the occurrence of an event. When the action unit 342 detects the occurrence of an event, the action unit 342 takes action in the same manner as described above.

The identification unit 343 is an example of the identification unit 13 described above. The identification unit 343 performs an inappropriate rule detection process. The identification unit 343 analyzes each piece of history information in the history DB 313 in response to an update of the history DB 313 or at a predetermined timing to determine whether an occurrence trend of a specific occurred event satisfies the predetermined condition or not. In a case where there is an occurred event that satisfies the predetermined condition, the identification unit 343 identifies the rule ID (rule information) associated with the occurred event. Specifically, the identification unit 343 analyzes the occurrence trend of the specific event based on a plurality of occurrence dates and times of the specific event. Then, in a case where the identification unit 343 detects a change in the occurrence trend before and after a predetermined time point, the identification unit 343 determines that the occurrence interval satisfies the predetermined condition. Then, the identification unit 343 identifies, from among the plurality of rule information, the rule information defining the event that is determined to satisfy the predetermined condition. As described above, rule information that defines an event for which a change in the occurrence trend is detected is likely not appropriate for the current operation system 100 in terms of its rule conditions and actions. Therefore, it is possible to support the administrator in considering whether to modify the rule information or not.

In particular, in a case where the identification unit 343 detects that the occurrence frequency of the specific event is higher than that before the predetermined time point, the identification unit 343 may determine that the occurrence interval satisfies the predetermined condition. That is, when the latest occurrence interval of the specific event is (significantly) shorter than the average of the past occurrence intervals, the rule is likely to be inappropriate. Therefore, it is possible to support the administrator in considering whether to modify the rule information or not. Furthermore, in a case where a predetermined period or more has elapsed since the last occurrence of the specific event, the identification unit 343 may determine that the occurrence interval satisfies the predetermined condition. In this case, an event that had a predetermined occurrence interval in the past may no longer occur, or the status may have changed due to modifications or the like of the operation system 100. Therefore, it is likely that the rule information is no longer needed or inappropriate for the current operation system 100. Therefore, it is possible to support the administrator in considering whether to modify or delete the rule information or not. In addition, from a plurality of occurrence dates and times for the specific event, the identification unit 343 may calculate a first occurrence frequency of the event in a period before the predetermined time point and a second occurrence frequency of the event in a period after the predetermined time point as occurrence trends. In this case, the identification unit 343 determines whether the occurrence interval satisfies a predetermined condition from the relationship between the first and second occurrence frequencies. As a result, changes in the occurrence trend of the specific event can be more accurately detected by the degree of difference in the occurrence frequency before and after the predetermined time point as a reference.

The output unit 344 is an example of the output unit 14 described above. The output unit 344 outputs the identified rule information to the management terminal 200. Further, the output unit 344 outputs the reason for detecting the change in the occurrence trend together with the identified rule information to the management terminal 200. The reason for detecting a change in the occurrence trend is, for example, that the occurrence frequency of the specific event is higher than that before the predetermined time point, that a predetermined period or more has elapsed since the last occurrence of the specific event, or the relationship (comparison result) between the first and second occurrence frequencies described above. Furthermore, the output unit 344 may further output information on the event that occurred. Note that, in addition to the management terminal 200, the output unit 344 may output to a display device connected to the operation support apparatus 300 or another information system.

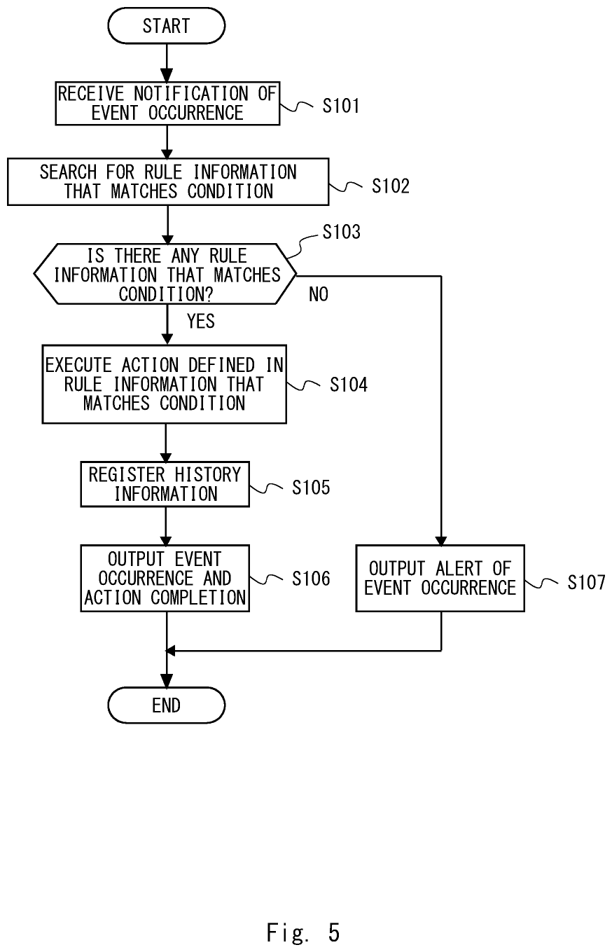

FIG. 5 is a flowchart illustrating a flow of an action process for the occurred event according to the second example embodiment. As a premise, it is assumed that the operation support apparatus 300 has a plurality of rule information 3121, etc. already registered in the rule DB 312, and that execution command and the like corresponding to the action defined in each piece of rule information also have been registered or at least can be executed via the network N. Then, it is assumed that a predetermined event (failure or the like) occurs in the monitoring target device in the operation system 100, for example, the server 110. For example, the monitoring device 400 detects the addition of an error message from the log file 112 or the like of the server 110 and transmits the error message as a notification of event occurrence to the operation support apparatus 300 via the network N. The notification of the event occurrence includes a message ID, the message content, occurrence date and time (date and time of detection), identification information of the detected monitoring target device (server 110), and the like.

Therefore, the action unit 342 of the operation support apparatus 300 receives a notification of event occurrence from the monitoring device 400 via the network N (S101). Note that the action unit 342 may also receive a notification of event occurrence from monitoring software in the server 110 via the network N. Alternatively, the action unit 342 may acquire monitoring target information (such as the log file 112) from the server 110 via the network N, analyze the monitoring target information to detect the occurrence of a predetermined event.

Next, the action unit 342 searches in the rule DB 312 for rule information that matches the condition (S102). Specifically, the action unit 342 searches for an event (error message ID or the like) included in the occurrence notification that matches the condition of each rule information in the rule DB 312. Then, the action unit 342 determines whether there is rule information matching the condition or not (S103). For example, when the error message ID included in the occurrence notification is included in the condition 31212, the action unit 342 determines that there is rule information that matches the condition, and identifies the rule information 3121 in which the condition 31212 is defined. Then, the action unit 342 executes the action defined in the rule information that matches the condition (S104). For example, the action unit 342 executes an execution command corresponding to the action 31213 defined in the identified rule information 3121 with respect to the server 110 via the network N. Then, the execution of the execution command is considered to have been completed.

Thereafter, the registration unit 341 registers the history information in the history DB 313 (S105). Specifically, the registration unit 341 sets the error message ID included in the occurrence notification as the occurred event 31311, the occurrence date and time included in the occurrence notification as the occurrence date and time 31312, and the rule ID 31211 of the identified rule information 3121 as the rule ID 31313. Then, the registration unit 341 registers the occurred event 31311, the occurrence date and time 31312, the rule ID 31313, and the execution result 31314 of the action taken in association with each other in the history DB 313 as the history information 3131.

Then, the action unit 342 outputs the event occurrence and the completion of the action to the management terminal 200 (S106). For example, the action unit 342 outputs the error message ID and the execution result 31314 included in the occurrence notification to the management terminal 200. On the other hand, when it is determined in step S103 that there is no rule information matching the condition, the action unit 342 outputs an alert of event occurrence to the management terminal 200 (S107).

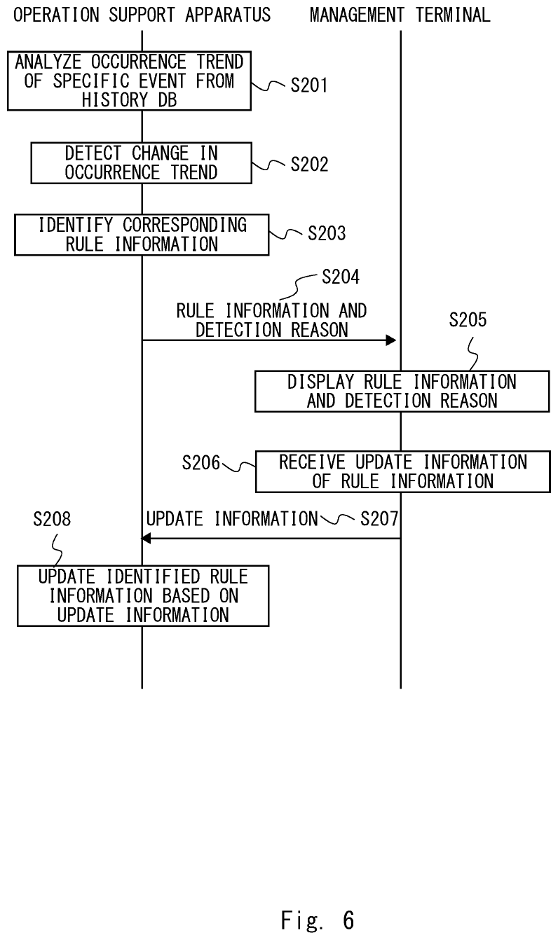

FIG. 6 is a sequence diagram illustrating a flow of an inappropriate rule detection and update process according to the second example embodiment. For example, the identification unit 343 starts the inappropriate rule detection process after the action process in FIG. 5. Alternatively, the identification unit 343 may start the inappropriate rule detection process at a predetermined timing.

First, the identification unit 343 analyzes the occurrence trend of a specific event from the history DB 313 (S201). Specifically, the identification unit 343 identifies a history information group from the history DB 313 whose occurred event is a specific error message ID, and acquires the occurrence date and time of the identified history information group. Then, the identification unit 343 calculates the interval between adjacent dates and times (occurrence interval) when each of the acquired occurrence dates and times are arranged in chronological order. At this time, the identification unit 343 calculates the first occurrence frequency from a plurality of occurrence intervals in the period before the predetermined time point, and calculates the second occurrence frequency from one or more occurrence intervals in the period after the predetermined time point. Here, the first occurrence frequency and the second occurrence frequency are examples of the occurrence trend. In addition, the identification unit 343 may analyze the occurrence trend using another algorithm, analysis logic, or the like.

Next, the identification unit 343 detects a change in the occurrence trend (S202). For example, the identification unit 343 detect that the second occurrence frequency has increased relative to the first occurrence frequency as a change in the occurrence trend. In addition, the identification unit 343 may detect that the second occurrence frequency has decreased relative to the first occurrence frequency, for example, that the second occurrence frequency is zero, as a change in the occurrence trend. Note that, in a case where the change in the occurrence trend is not detected in step S202, the process ends. Alternatively, the inappropriate rule detection process is performed for another event.

Then, the identification unit 343 identifies the rule information corresponding to the event for which a change in the occurrence trend is detected (S203). Specifically, the identification unit 343 identifies the rule ID 31313 associated with the occurred event 31311, which is a specific error message ID. In addition, the identification unit 343 identifies the reason for the detection (the reason for detecting a change in the occurrence trend).

Thereafter, the output unit 344 transmits the identified rule information and a detection reason to the management terminal 200 via the network N (S204). In response to this, the management terminal 200 displays on its screen the rule information and the detection reason received from the operation support apparatus 300 via the network N. As a result, the operation manager can visually recognize the rules that are likely to be inappropriate and the reasons why. Thus, the operation manager can consider whether the condition and action of the relevant rule information need to be modified or not and the details of the modification. Here, the operation manager shall modify the condition and action in the corresponding rule information. Therefore, the management terminal 200 receives update information of the rule information from the operation manager (S206). Then, the management terminal 200 transmits the update information to the operation support apparatus 300 via the network N (S207).

In response to this, the registration unit 341 of the operation support apparatus 300 updates the identified rule information based on the update information received from the management terminal 200 (S208). Specifically, the registration unit 341 updates the rule DB 312 with the content of the update information regarding the condition or action in the rule information corresponding to the update information.

In this manner, the operation support apparatus 300 can support maintenance of the rule information by the operation manager through the inappropriate rule detection and update process.

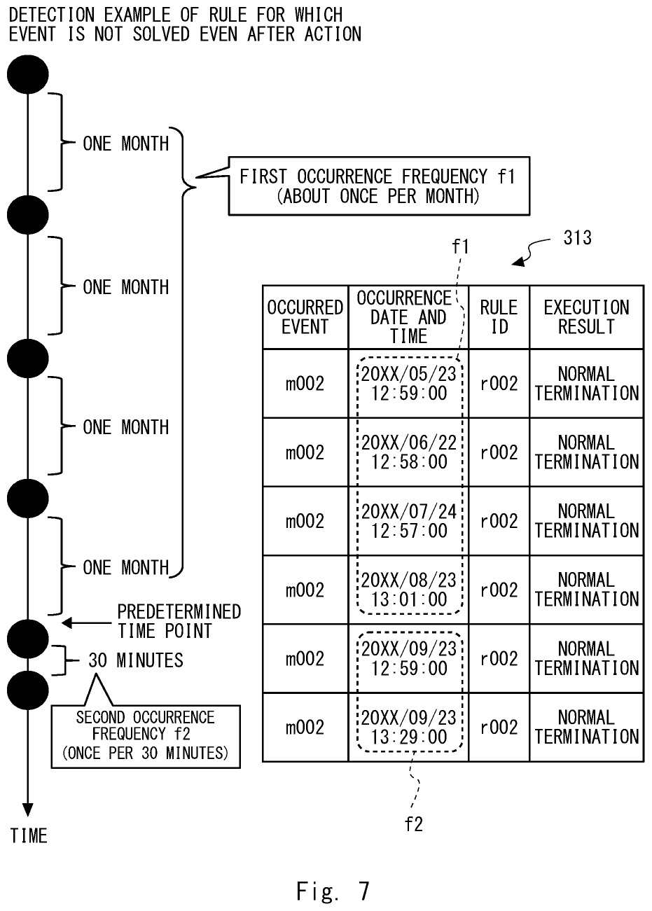

FIG. 7 is a diagram illustrating a concept of a detection example of a rule for which an event is not solved even after an action according to the second example embodiment. Black circles on the left side of FIG. 7 conceptually indicate the timing of occurrence of the event in chronological order. The history DB 313 on the right side of FIG. 7 is an example of displaying the pieces of history information for the occurred event “m002” in chronological order by occurrence date and time. This indicates that in the first period prior to the predetermined time point, the first occurrence frequency f1 is about once per month. In the second period after the predetermined time point, the second occurrence frequency f2 is once every 30 minutes. Therefore, for example, when the action at the occurrence date and time “20XX/09/23 13:29:00” is executed and the registration unit 341 registers the history information in the history DB 313, the identification unit 343 may start the inappropriate rule detection process. As a result, a change in the occurrence trend of the occurred event “m002” can be detected quickly, and, along with maintenance of the rules, other actions can be encouraged.

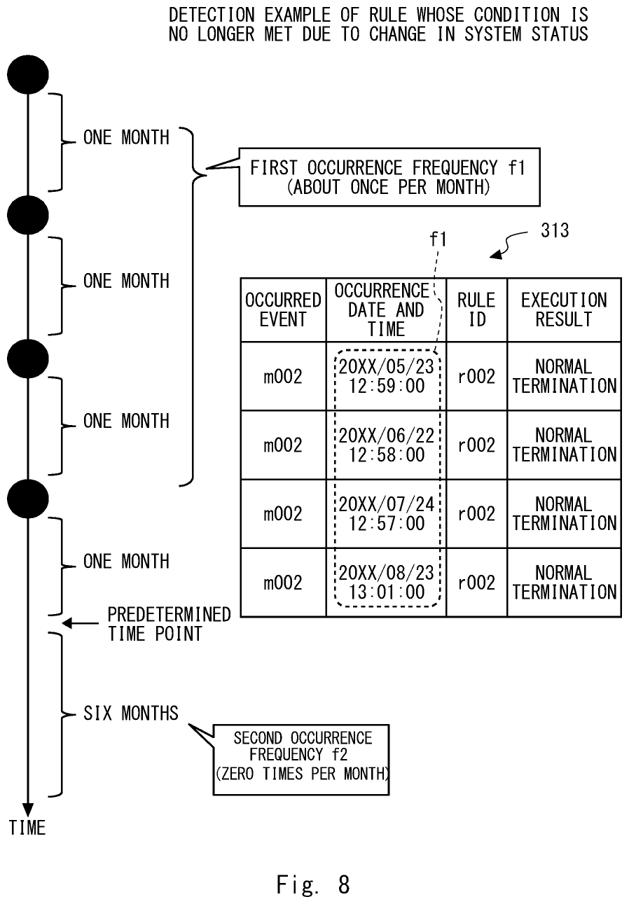

FIG. 8 is a diagram illustrating a concept of a detection example of a rule whose condition is no longer met due to a change in a system status according to the second example embodiment. This indicates that in the first period prior to the predetermined time point, the first occurrence frequency f1 is about once per month. In the second period after the predetermined time point, the second occurrence frequency f2 is zero per month, that is, it has not occurred for six months or more after the predetermined time point. In other words, it indicates that the event “m002” has never occurred and no action has been taken in a period significantly exceeding the execution frequency so far. Therefore, it is considered that there is some reason why the event “m002” no longer occurs. In addition, since the action conditional on the event “m002” has not been executed, it is possible that appropriate action has not been taken for the operation system 100. Therefore, the identification unit 343 preferably starts the inappropriate rule detection process periodically. As a result, rules that are not functioning or unnecessary can be detected and maintenance can be encouraged.

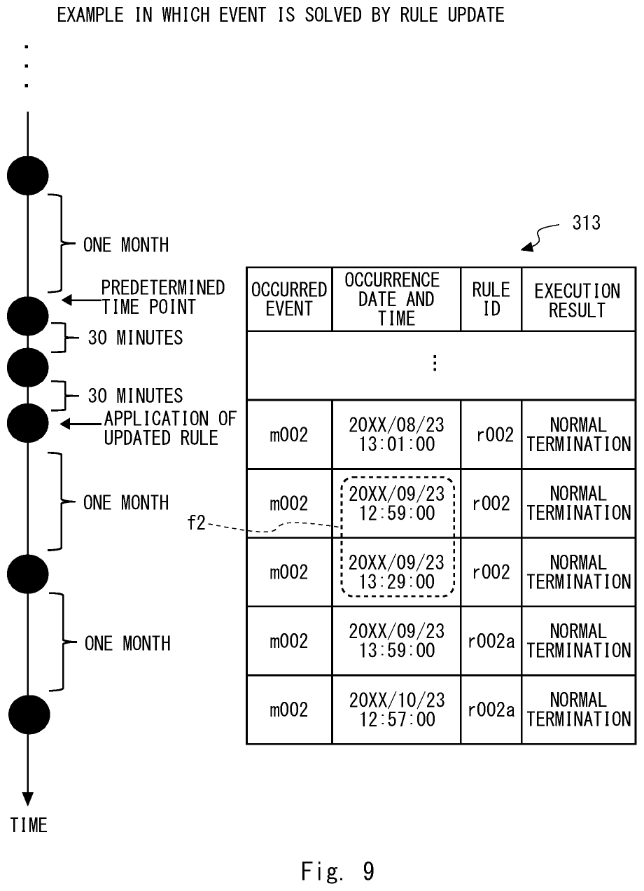

FIG. 9 is a diagram illustrating a concept of an example in which an event is solved by rule update according to the second example embodiment. Here, as a premise, it is assumed that an inappropriate rule is detected in the example in FIG. 7 described above, the rule information and the reason for the detection are notified to the management terminal 200, and the rule information corresponding to the event “m002” is updated accordingly.

Specifically, it is assumed that the rule information corresponding to the event “m002” is updated to the rule ID “r002a” and the action to be taken to another execution command after the action with the rule ID “r002” is executed on the occurrence date and time “20XX/09/23 13:29:00”. As a result, it is assumed that, at the occurrence date and time “20XX/09/23 13:59:00”, which is 30 minutes after the previous occurrence of the event “m002”, the rule ID “r002a” shall be identified and the updated execution command shall be executed as the action and shall have ended normally. Therefore, thereafter, it is indicated that the event “m002” no longer recurs after 30 minutes, and the event “m002” has returned to occur in about one month as before. Therefore, the present example embodiment can detect inappropriate rules that no longer function and encourage correction and the like, thereby supporting the proper maintenance of the rule for taking action on the event that occurred in the operation system.

### Other Example Embodiments

Note that, in the above-described example embodiments, the configuration of the hardware has been described, but the present disclosure is not limited thereto. The present disclosure can also be realized by causing a CPU to execute a computer program.

In the above example, the program may be stored using various types of non-transitory computer-readable media and supplied to a computer. The non-transitory computer-readable media include various types of tangible storage media. Examples of the non-transitory computer-readable media include a magnetic recording medium (for example, a flexible disk, a magnetic tape, or a hard disk drive), a magneto-optical recording medium (for example, a magneto-optical disc), a CD-read only memory (ROM), a CD-R, a CD-R/W, a digital versatile disc (DVD), and semiconductor memories (for example, a mask ROM, a programmable ROM (PROM), an erasable PROM (EPROM), a flash ROM, and a random access memory (RAM)). In addition, the program may be supplied to the computer by any of various types of transitory computer-readable media. Examples of the transitory computer-readable media include electrical signals, optical signals, and electromagnetic waves. The transitory computer-readable media can supply programs to computers via wired or wireless communication paths, such as wires and optical fiber.

Note that the present disclosure is not limited to the above example embodiments, and can be appropriately changed without departing from the gist. Furthermore, the present disclosure may be implemented by appropriately combining the respective example embodiments.

Some or all of the above-described example embodiments may be described as the following supplementary notes, but are not limited to the following.

(Supplementary Note A1)

An operation support apparatus comprising:
a storage unit configured to store a plurality of pieces of rule information defining actions respectively corresponding to a plurality of events occurring in an operation system;
a registration unit configured to register history information in the storage unit in a case where an action defined in rule information corresponding to a predetermined event among the plurality of pieces of rule information is taken in response to an occurrence of the predetermined event in the operation system, the history information containing occurrence date and time of the event and the rule information for the event;
an identification unit configured to identify, based on the history information, rule information in which an occurrence interval of a specific event satisfies a predetermined condition; and
an output unit configured to output the identified rule information.

(Supplementary Note A2)

The operation support apparatus according to Supplementary Note A1, wherein
the identification unit is configured to:
analyze an occurrence trend of the event from a plurality of occurrence dates and times in the specific event;
determine that the occurrence interval satisfies a predetermined condition in a case where a change in a trend before or after a predetermined time point is detected from the occurrence trend; and
identify, from among the plurality of pieces of rule information, rule information defining the event that is determined to satisfy the predetermined condition.

(Supplementary Note A3)

The operation support apparatus according to Supplementary Note A2, wherein
the identification unit is configured to determine that the occurrence interval satisfies the predetermined condition in a case where it is detected that an occurrence frequency of the specific event becomes higher than that before the predetermined time point.

(Supplementary Note A4)

The operation support apparatus according to Supplementary Note A2 or A3, wherein
the identification unit is configured to determine that the occurrence interval satisfies the predetermined condition in a case where a predetermined period of time or more has elapsed since a last occurrence of the specific event.

(Supplementary Note A5)

The operation support apparatus according to any one of Supplementary Notes A2 to A4, wherein
the identification unit is configured to:
calculate, from the plurality of occurrence dates and times in the specific event, a first occurrence frequency of the event in a period of time before the predetermined time point and a second occurrence frequency of the event in a period of time after the predetermined time point as the occurrence trend; and
determine whether the occurrence interval satisfies a predetermined condition or not based on a relationship between the first occurrence frequency and the second occurrence frequency.

(Supplementary Note A6)

The operation support apparatus according to any one of Supplementary Notes A2 to A5, wherein
the output unit is configured to further output a reason why the change in the occurrence trend is detected together with the identified rule information.

(Supplementary Note B1)

An operation support system comprising:
a management terminal; and
an operation support apparatus, wherein
the operation support apparatus is configured to:
receive, from the management terminal, a plurality of pieces of rule information defining actions respectively corresponding to a plurality of events occurring in an operation system, and store the plurality of pieces of rule information in a storage device;
register history information in the memory device when an action defined in the rule information corresponding to a predetermined event among the plurality of pieces of rule information is taken in response to occurrence of the predetermined event in the operation system, the history information containing occurrence date and time of the event and the rule information for the event;
identify, based on the history information, rule information in which an occurrence interval of a specific event satisfies a predetermined condition; and
output the identified rule information to the management terminal.

(Supplementary Note B2)

The operation support system according to Supplementary Note B1, wherein
the management terminal is configured to:
display the rule information output from the operation support apparatus; and
transmit update information of the rule information to the operation support apparatus, and
the operation support apparatus is configured to update the identified rule information based on the update information received from the management terminal.

(Supplementary Note C1)

An operation support method of causing a computer to execute:
in a case where an action defined in rule information corresponding to a predetermined event among a plurality of pieces of rule information stored in a storage device configured to store the plurality of pieces of rule information defining actions respectively corresponding to a plurality of events occurring in an operation system is taken in response to the occurrence of the predetermined event in the operation system, registering history information in the memory device, the history information containing occurrence date and time of the event and the rule information for the event;
identifying, based on the history information, rule information in which an occurrence interval of a specific event satisfies a predetermined condition; and
outputting the identified rule information.

(Supplementary Note D1)

An operation support program for causing a computer to execute:
in a case where an action defined in rule information corresponding to a predetermined event among a plurality of pieces of rule information stored in a storage device configured to store the plurality of pieces of rule information defining actions respectively corresponding to a plurality of events occurring in an operation system is taken in response to the occurrence of the predetermined event in the operation system, a process of registering history information in the memory device, the history information containing occurrence date and time of the event and the rule information for the event;
a process of identifying, based on the history information, rule information in which an occurrence interval of a specific event satisfies a predetermined condition; and
a process of outputting the identified rule information.

The present invention has been described with reference to the example embodiments (and examples). However, the present invention is not limited to the above-described example embodiments (and examples). Various changes that can be understood by those skilled in the art can be made to the configurations and details of the present invention within the scope of the present invention.

This application claims priority based on Japanese Patent Application No. 2021-045848 filed on Mar. 19, 2021, the entire disclosure of which is incorporated herein.

### REFERENCE SIGNS LIST

1 OPERATION SUPPORT APPARATUS
11 STORAGE UNIT
12 REGISTRATION UNIT
13 IDENTIFICATION UNIT
14 OUTPUT UNIT
15l RULE INFORMATION
15n RULE INFORMATION
16l HISTORY INFORMATION
16m HISTORY INFORMATION
1000 OPERATION SUPPORT SYSTEM
100 OPERATION SYSTEM
110 SERVER
111 SETTING INFORMATION
112 LOG FILE
200 MANAGEMENT TERMINAL
300 OPERATION SUPPORT APPARATUS
310 STORAGE UNIT
311 PROGRAM
312 RULE DB
3121 RULE INFORMATION
31211 RULE ID
31212 CONDITIONS
31213 ACTION
312n RULE INFORMATION
313 HISTORY DB
3131 HISTORY INFORMATION
31311 OCCURRED EVENT
31312 OCCURRENCE DATE AND TIME
31313 RULE ID
31314 EXECUTION RESULT
313m HISTORY INFORMATION
320 MEMORY
330 COMMUNICATION UNIT
340 CONTROL UNIT
341 REGISTRATION UNIT
342 ACTION UNIT
343 IDENTIFICATION UNIT
344 OUTPUT UNIT
400 MONITORING DEVICE
N NETWORK
f1 FIRST OCCURRENCE FREQUENCY
f2 SECOND OCCURRENCE FREQUENCY

What is claimed is:

1. An operation support apparatus comprising:
a memory storing instructions; and
a processor configured to execute the instructions to:
store a plurality of pieces of rule information defining actions respectively corresponding to a plurality of events occurring in an operation system in the memory;
register history information in the memory in a case where an action defined in rule information corresponding to a predetermined event among the plurality of pieces of rule information is taken in response to an occurrence of the predetermined event in the operation system, the history information containing occurrence date and time of the event and the rule information for the event;
identify, based on the history information, rule information in which an occurrence interval of a specific event satisfies a predetermined condition; and
output the identified rule information.

2. The operation support apparatus according to claim 1, wherein
the processor is configured to:
analyze an occurrence trend of the event from a plurality of occurrence dates and times in the specific event;
determine that the occurrence interval satisfies a predetermined condition in a case where a change in a trend before or after a predetermined time point is detected from the occurrence trend; and
identify, from among the plurality of pieces of rule information, rule information defining the event that is determined to satisfy the predetermined condition.

3. The operation support apparatus according to claim 2, wherein
the processor is configured to determine that the occurrence interval satisfies the predetermined condition in a case where it is detected that an occurrence frequency of the specific event becomes higher than that before the predetermined time point.

4. The operation support apparatus according to claim 2, wherein
the processor is configured to determine that the occurrence interval satisfies the predetermined condition in a case where a predetermined period of time or more has elapsed since a last occurrence of the specific event.

5. The operation support apparatus according to claim 2, wherein
the processor is configured to:
calculate, from the plurality of occurrence dates and times in the specific event, a first occurrence frequency of the event in a period of time before the predetermined time point and a second occurrence frequency of the event in a period of time after the predetermined time point as the occurrence trend; and
determine whether the occurrence interval satisfies a predetermined condition or not based on a relationship between the first occurrence frequency and the second occurrence frequency.

6. The operation support apparatus according to claim 2, wherein
the processor is configured to further output a reason why the change in the occurrence trend is detected together with the identified rule information.

7. An operation support system comprising:
a management terminal; and
an operation support apparatus, wherein
the operation support apparatus is configured to:
receive, from the management terminal, a plurality of pieces of rule information defining actions respectively corresponding to a plurality of events occurring in an operation system, and store the plurality of pieces of rule information in a storage device;
register history information in the memory device when an action defined in the rule information corresponding to a predetermined event among the plurality of pieces of rule information is taken in response to occurrence of the predetermined event in the operation system, the history information containing occurrence date and time of the event and the rule information for the event;
identify, based on the history information, rule information in which an occurrence interval of a specific event satisfies a predetermined condition; and
output the identified rule information to the management terminal.

8. The operation support system according to claim 7, wherein
the management terminal is configured to:
display the rule information output from the operation support apparatus; and
transmit update information of the rule information to the operation support apparatus, and
the operation support apparatus is configured to update the identified rule information based on the update information received from the management terminal.

9. (canceled)

10. A non-transitory computer-readable medium storing an operation support program for causing a computer to execute:
in a case where an action defined in rule information corresponding to a predetermined event among a plurality of pieces of rule information stored in a storage device configured to store the plurality of pieces of rule information defining actions respectively corresponding to a plurality of events occurring in an operation system is taken in response to the occurrence of the predetermined event in the operation system, a process of registering history information in the memory device, the history information containing occurrence date and time of the event and the rule information for the event;
a process of identifying, based on the history information, rule information in which an occurrence interval of a specific event satisfies a predetermined condition; and
a process of outputting the identified rule information.
